(19) United States
(12) Patent Application Publication
(10) Pub. No.: US 2026/0095382 A1
(43) Pub. Date: Apr. 2, 2026

(54) Content Preparation and Rendering Based on Device Energy Level

(71) Applicant: Bank of America Corporation, Charlotte, NC (US)

(72) Inventors: George Albero, Charlotte, NC (US); Naga Vamsi Krishna Akkapeddi, Charlotte, NC (US); Igor Derensteyn, Woodland Hills, CA (US); Sridhar Chakilam, Hyderabad (IN); Rohit Aggarwal, Haryana (IN); Bharat Chabra, Hyderabad (IN)

(21) Appl. No.: 18/899,196

(22) Filed: Sep. 27, 2024

(51) Int. Cl. H04L 41/147; H04L 43/08

(52) U.S. Cl. CPC H04L 41/147; H04L 43/08

(57) ABSTRACT

Arrangements for providing content preparation and rendering based on device energy levels are provided. A computing platform may receive current device energy level, application usage and scheduled transaction data from a first device. The platform may execute a machine learning model, using the received data as inputs, to output a predicted consumption rate of energy for the first device, and a determination of whether sufficient energy will be available to process a scheduled transaction. If sufficient energy will not be available, the model may divide the scheduled transaction into a plurality of splits and identify an order to execute the splits to process the transaction. A second device may be identified and a first portion of the plurality of splits may be transmitted to the second device for execution. A second portion of the splits may be transmitted to the first device for execution and the transaction may be processed.

### BACKGROUND

Aspects of the disclosure relate to electrical computers, systems, and devices for content preparation and rendering based on device energy data.

Users may schedule transactions for executing using a wearable device, such as a smart watch, or the like. However, wearable devices often have limited battery life or capacity. Further, users are often using one or more applications, such as global positioning system or navigation applications, or the like, on the device throughout the day, which can draw down the battery of the device. This may lead to issues in processing scheduled transactions if insufficient battery is available to process the transaction. Accordingly, aspects described herein provide arrangements for executing transactions using multiple devices based on energy level of one or more devices.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with monitoring device energy status to ensure proper execution of processes by the device.

In some examples, a computing platform may receive current device energy level data, application usage data and scheduled transaction data from a first user computing device. In some examples, the first user computing device may be a wearable device having limited battery capacity. The computing platform may input the received data to a machine learning model and may execute the machine learning model to output a predicted consumption rate of energy for the first user computing device, as well as a determination of whether sufficient energy will be available to process a scheduled transaction identified from the scheduled transaction data. If sufficient energy is likely to be available, the scheduled transaction may be processed at a scheduled time by the first user computing device.

If sufficient energy is not likely to be available, the machine learning model may divide the scheduled transaction into a plurality of splits for low energy processing. The machine learning model may also identify an order or sequence in which to execute the splits in order to process the transaction. A second user computing device may be identified based on proximity to the first user computing device and a first portion of the plurality of splits may be transmitted to the second user computing device for execution. A second portion of the plurality of splits may be transmitted to the first user computing device for execution and the transaction may be processed by both devices.

In some examples, additional data related to device energy capacity, application energy usage, and the like, may be retrieved and used, as additional inputs to the machine learning model, to output the predicted consumption rate and determination of sufficient energy.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing content preparation and rendering based on device energy level in accordance with one or more aspects described herein;

FIGS. 2A-2H depict an illustrative event sequence for content preparation and rendering based on device energy level in accordance with one or more aspects described herein;

FIG. 3 illustrates an illustrative method for content preparation and rendering based on device energy level according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, users often schedule transactions for execution by a wearable device associated with the user. However, because battery life is limited with wearable devices, and available battery is dependent on consumption of one or more other applications being used by the user, processing scheduled transactions can be interrupted due to insufficient battery. Accordingly, aspects described herein provide for a machine learning model that may receive, as inputs, current battery status, consumption data, transaction data, and/or device and application benchmark data and may project a consumption rate of energy associated with a first device, as well as determine whether sufficient battery will be available to process a scheduled transaction at the scheduled time. If sufficient battery is expected to be available, the transaction may be processed by the wearable device as scheduled.

However, if sufficient battery is not expected to be available, the machine learning model may divide the transaction into a plurality of transaction splits. Each transaction split may be associated with a portion of the transaction and the transaction splits, when executed in an identified order, may constitute processing of the transaction. In some examples, one or more additional devices (e.g., a smart phone, tablet or other device) may be identified and a first portion of the plurality of splits may be transmitted to the one or more additional device for execution in the identified order, while a second or remaining portion of the plurality of splits may be processed by the wearable device.

These and various other arrangements will be discussed more fully below.

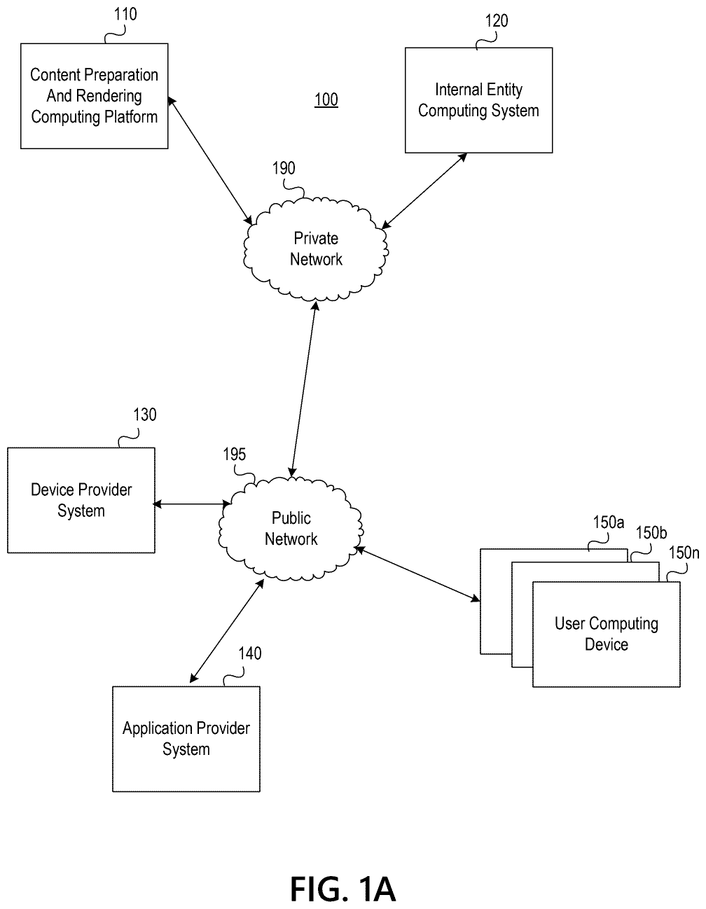

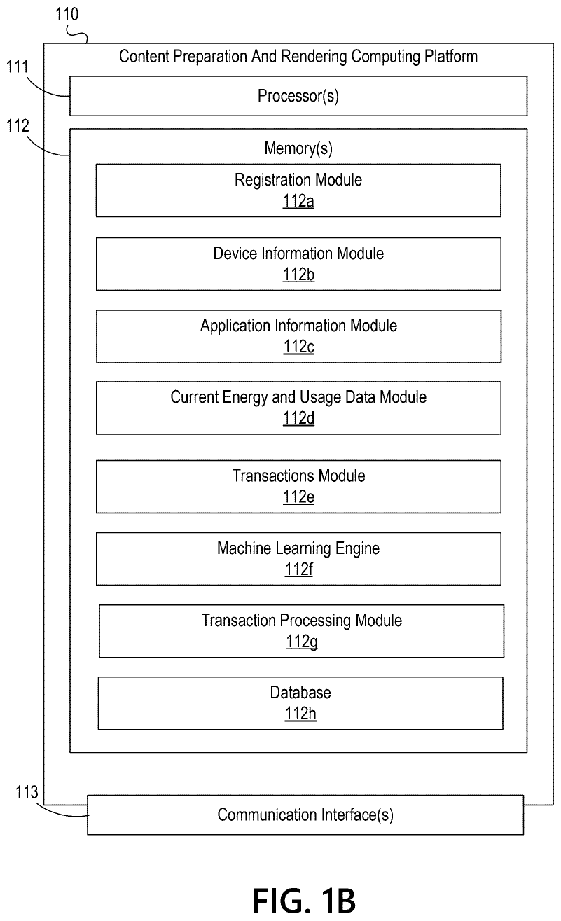

FIGS. 1A-1B depict an illustrative computing environment and devices for implementing content preparation and rendering based on device energy functions in accordance with one or more aspects described herein. Referring to FIG. 1A, computing environment 100 may include one or more computing devices and/or other computing systems. For example, computing environment 100 may include content preparation and rendering computing platform 110, internal entity computing system 120, device provider system 130, application provider system 140, and user computing devices 150a-150n.

Although one internal entity computing system 120, one device provider system 130, one application provider system 140 and three user devices, 150a, 150b, 150n are shown, any number of systems or devices may be used without departing from the invention.

Content preparation and rendering computing platform 110 may be configured to perform intelligent, dynamic, content preparation and rendering based on device energy levels. For instance, content preparation and rendering computing platform 110 may receive data from a first user computing device 150a. The data may include calendar data indicating scheduled payments to be made that day (e.g., a current calendar day, a current business day or the like). In addition, the data may include data related to current energy level of the device (e.g., percent or other amount of battery left in the user computing device 150a). The data may further include device usage data including applications executing in the background and foreground of the user computing device 150a.

Content preparation and rendering computing platform 110 may further receive data related to expected energy usage, consumption and the like for a type of device associated with user computing device 150a. For instance, content preparation and rendering computing platform 110 may connect to device provider system 130 and retrieve published data related to energy consumption, capacity, and the like, for the type of device associated with user computing device 150a.

Content preparation and rendering computing platform 110 may further receive data related to expected energy usage, consumption and the like for the one or more applications executing on the user computing device 150a. For instance, content preparation and rendering computing platform 110 may connect to application provider system 140 and retrieve published data related to energy consumption associated with one or more applications currently executing on the user computing device 150a.

Content preparation and rendering computing platform 110 execute a machine learning model. For instance, content preparation and rendering computing platform 110 may input, to the machine learning model, the current energy level of user computing device 150a, the calendar data including scheduled or expected transactions for execution, the application data associated with the user computing device 150a, as well as the device provider data and application provider data received. The machine learning model may be executed and may output a projected consumption rate of energy associated with the user computing device 150a, and a determination of whether sufficient energy will be held by the user computing device 150a when a time to execute a scheduled transaction occurs. If sufficient energy is expected to be available based on the projected consumption rate of energy by user computing device 150a, the transaction may be processed at the scheduled time and the process may end.

If sufficient energy is not expected to be available, the machine learning model may identify one or more transaction splits for the scheduled transaction. For instance, based on a type or category of the scheduled transaction, the machine learning model may divide the transaction into a plurality of transaction splits, where each split represents a portion or step in the processing of the full transaction. The machine learning model may also identify an order in which the plurality of splits will be performed to process the scheduled transaction. By dividing the transaction into the plurality of splits, less energy may be consumed in processing the transaction because a portion of the splits may be performed by another device.

For instance, content preparation and rendering computing platform 110 may determine whether one or more other user computing devices (e.g., 150b, 150n, or the like), are available (e.g., whether a connection is available to one or more other devices via, for instance, near-field communication, Bluetooth, Bluetooth LE, or the like. If so, the content preparation and rendering computing platform 110 may transmit or send a first portion of the plurality of splits to the one or more other devices, for instance, user computing device 150b, to execute the first portion of the splits. Once the first portion is executed, data may be transmitted to user computing device 150a which may trigger execution of a second portion of the plurality of splits, which may complete the processing of the transaction. While this example includes a portion of the transaction splits being processed by the first user computing device, in some examples, all splits in the plurality of splits may be performed by other computing devices (e.g., 150b, 150n, or the like).

Internal entity computing system 120 may be or include one or more computer components (e.g., servers, server blades, memory, processors, or the like) and may host or execute one or more enterprise organization functions associated with transaction processing. For instance, internal entity computing system 120 may host or execute applications or systems associated with transferring funds to, from or between accounts, updating an account ledger, or the like.

Device provider system 130 may be or include one or more computer components (e.g., servers, server blades, memory, processors, or the like) and may store publicly available data related to energy capacity (e.g., expected or benchmarked battery life), consumption and the like, for a particular device or type of device (e.g., make, model, or the like).

Application provider system 140 may be or include one or more computer components (e.g., servers, server blades, memory, processors, or the like) and may store publicly available data related to energy consumption (e.g., expected or benchmarked energy consumption) associated with one or more applications.

User computing device 150a-150n may be or include one or more computing devices, such as a laptop computer, desktop computer, smartphone, mobile device, wearable device, or the like and may be configured to schedule and execute transactions, connect to one or more other devices, and the like. User computing device 150a-150n may also include one or more applications for navigation, reading email or SMS messages, tracking fitness or fitness parameters, or the like.

As mentioned above, computing environment 100 also may include one or more networks, which may interconnect one or more of content preparation and rendering computing platform 110, internal entity computing system 120, device provider system 130, application provider system 140, and/or user computing devices 150a-150n. For example, computing environment 100 may include private network 190. Private network 190 may include one or more sub-networks (e.g., Local Area Networks (LANs), Wide Area Networks (WANs), or the like). Private network 190 may interconnect one or more computing devices associated with the organization. For example, content preparation and rendering computing platform 110 and internal entity computing system 120 may be connected via private network 190. Computing environment 100 may further include public network 195. Public network 195 may include one or more sub-networks (e.g., Local Area Networks (LANs), Wide Area Networks (WANs), or the like). Public network 195 may interconnect one or more computing devices outside the organization. For example, device provider system 130, application provider system 140, and/or user computing devices 150a-150n may be connected via public network 195, which may also connect device provider system 130, application provider system 140, and/or user computing devices 150a-150n to devices connected via the private network (e.g., content preparation and rendering computing platform 110, internal entity computing system 120, and the like).

Referring to FIG. 1B, content preparation and rendering computing platform 110 may include one or more processors 111, memory 112, and communication interface 113. A data bus may interconnect processor(s) 111, memory 112, and communication interface 113. Communication interface 113 may be a network interface configured to support communication between content preparation and rendering computing platform 110 and one or more networks (e.g., network 190, network 195, or the like). Memory 112 may include one or more program modules having instructions that when executed by processor(s) 111 content preparation and rendering computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of content preparation and rendering computing platform 110 and/or by different computing devices that may form and/or otherwise make up content preparation and rendering computing platform 110.

For example, memory 112 may have, store and/or include registration module 112a. Registration module 112a may store instructions and/or data that may cause or enable the content preparation and rendering computing platform 110 to receive registration data associated with one or more user devices. For instance, a user may request to register with the content preparation and rendering computing platform 110 and may provide permission for the content preparation and rendering computing platform 110 to monitor device usage, energy levels, and the like. In some examples, the registration data may include identification of one or more user devices, such as a smart phone, wearable device, tablet, or the like, unique identification number associated with each device, user identifying information, and the like.

Content preparation and rendering computing platform 110 may further have, store and/or include device information module 112b. Device information module 112b may store instruction and/or data that may cause or enable the content preparation and rendering computing platform 110 to connect to a device provider system 130 to retrieve device benchmark data. For instance, content preparation and rendering computing platform 110 may retrieve data from a particular manufacturer or other device provider including information related to energy capacity (e.g., expected or benchmarked battery life), consumption rates, and the like. The data may be particular to a type of device, model of the device, or the like. Although one device provider system 130 is shown, in some examples, data may be retrieved from a system associated with each device provider (e.g., each manufacturer) may be used without departing from the invention.

Content preparation and rendering computing platform 110 may further have, store and/or include application information module 112c. Application information module 112c may store instructions and/or data that may cause or enable the content preparation and rendering computing platform 110 to connect to one or more application provider systems 140 and retrieve benchmark data related to one or more applications. For instance, content preparation and rendering computing platform 110 may retrieve data related to expected energy consumption associated with one or more applications. Although one application provider system 140 is shown, in some examples, data may be retrieved from a system associated with each application provider (e.g., each manufacturer) may be used without departing from the invention.

Content preparation and rendering computing platform 110 may further have, store and/or include current energy and usage data module 112d. Current energy and usage data module 112d may store instructions and/or data that may cause or enable the content preparation and rendering computing platform 110 to retrieve, from a user device, such as user computing device 150a, data related to a current energy level and current application usage. For instance, a current batter level may be received, as well as identification of one or more applications currently executing on the application, as well as applications operating in the background of the device 150a.

Content preparation and rendering computing platform 110 may further have, store, and/or include transactions module 112e. Transactions module 112e may store instructions and/or data that may cause or enable the content preparation and rendering computing platform 110 to receive transaction data associated with one or more scheduled or expected transactions associated with a user device, such as user computing device 150a. In some examples, the data may be retrieved from a calendar application executing on the user computing device 150a. The transaction module 112e may receive data related to a type of transaction, time of execution of the transaction, and the like.

Content preparation and rendering computing platform 110 may further have, store and/or include machine learning engine 112f. Machine learning engine 112f may store instructions and/or data that may cause or enable the content preparation and rendering computing platform 110 to train, execute, update and/or validate one or more machine learning models to receive, as inputs, current device energy status data, application usage data, transaction data and generate or output a predicted consumption rate of energy for the device and a determination of whether sufficient energy will be available to process a scheduled transaction. In some examples, the machine learning model may further receive, as inputs, device specific benchmark data, application specific benchmark data, and the like, related to energy usage.

The machine learning model may be trained using previously captured and/or historical device, application and/or usage data. For instance, data associated with particular device (e.g., model and/or type of device), particular applications, particular types or categories of transactions, and the like, may be used to train the machine learning model to identify patterns or correlations in data in order to predict a consumption rate of energy for a device, as well as determine whether sufficient energy is expected to be available to process a transaction. For instance, data related to a particular wearable device, as well as applications executing on that device, an amount of energy consumed for each application, and the like, may be used to train the machine learning model to identify correlations. In some examples, data related to a number of application programming interface (API) calls associated with a category or type of transaction may also be used to train the machine learning model. For instance, each type of transaction may be associated with a number of API calls to one or more systems, devices, or the like, in order to complete processing of the transaction. Each API call may be associated with an amount of time and/or energy consumption which, when combined, may indicate a total time or energy consumption to process a particular type or category of transaction. In some examples, data from a plurality of users may be used to train the machine learning model in order to provide improved accuracy in predicted consumption rate and energy availability.

In some examples, the machine learning engine 112f may further train the machine learning model to determine a number of splits to generate for a particular transaction or type or category of transaction. For instance, if sufficient energy is not expected to be available to process the transaction, the machine learning model may determine or output a number of splits to enable “light processing” (e.g., smaller data packets) of the transaction that may reduce an amount of energy needed by the device (e.g., user computing device 150a) to process the transaction by sharing processing of the transaction. In some examples, historical data related to a number of splits for a particular type of category of transaction may be used to train the model to determine the number of splits for a particular transaction, as well as an order in which the splits must be performed to process the transaction.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data (e.g., labeled data including application and associated consumption rate, category of transaction and expected consumption, number and order of splits, and the like) and/or unlabeled data.

Accordingly, machine learning engine 112f may receive, as inputs to the machine learning model, current device energy status data, application usage data, transaction data and may generate or output a predicted consumption rate of energy for the device and may determine whether sufficient energy will be available to process a scheduled transaction.

Content preparation and rendering computing platform 110 may further have, store and/or include transaction processing module 112g. Transaction processing module 112g may store instructions and/or data that may cause or enable the content preparation and rendering computing platform 110 to receive, from the machine learning engine 112f, an indication of whether sufficient energy will be available to process the transaction and, if so, process the transaction using the user computing device 150a at a designated time. If sufficient energy is not expected to be available, transaction processing module 112g may identify one or more other devices (e.g., other registered user devices 150b, 150n) that may be nearby (e.g., within a connection range of near-field communication or other short-range communication protocol) and may share the processing load. Upon identifying one or more additional registered devices, the transaction processing module 112g may transmit or send a portion of the plurality of splits generated for the transaction to the additional device (e.g., user computing device 150b) for processing in a designated order. Transaction processing module 112g may also transmit or send a second portion of the plurality of splits to the user computing device 150a for execution in a particular order. Accordingly, the user computing devices 150a, 150b may process the transaction to completion by each processing a respective portion of the plurality of splits.

Content preparation and rendering computing platform 110 may further have, store and/or include database 112h. Database 112h may further store data related to device benchmark data, application benchmark data, usage data, transaction data, split data, and/or other data to perform the functions of the content preparation and rendering computing platform 110.

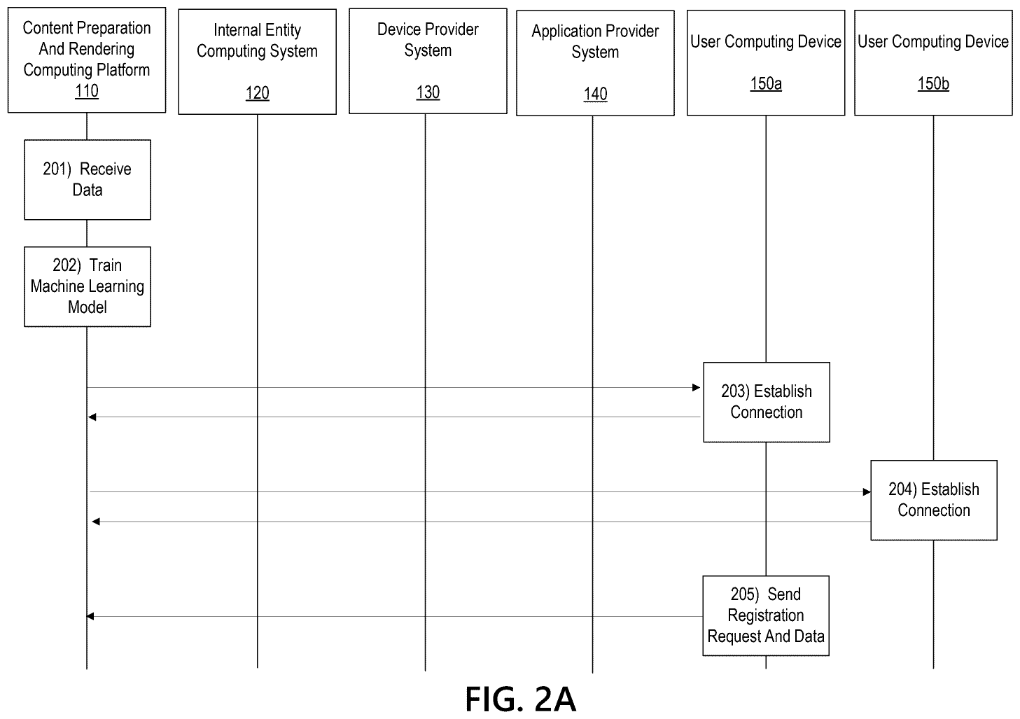

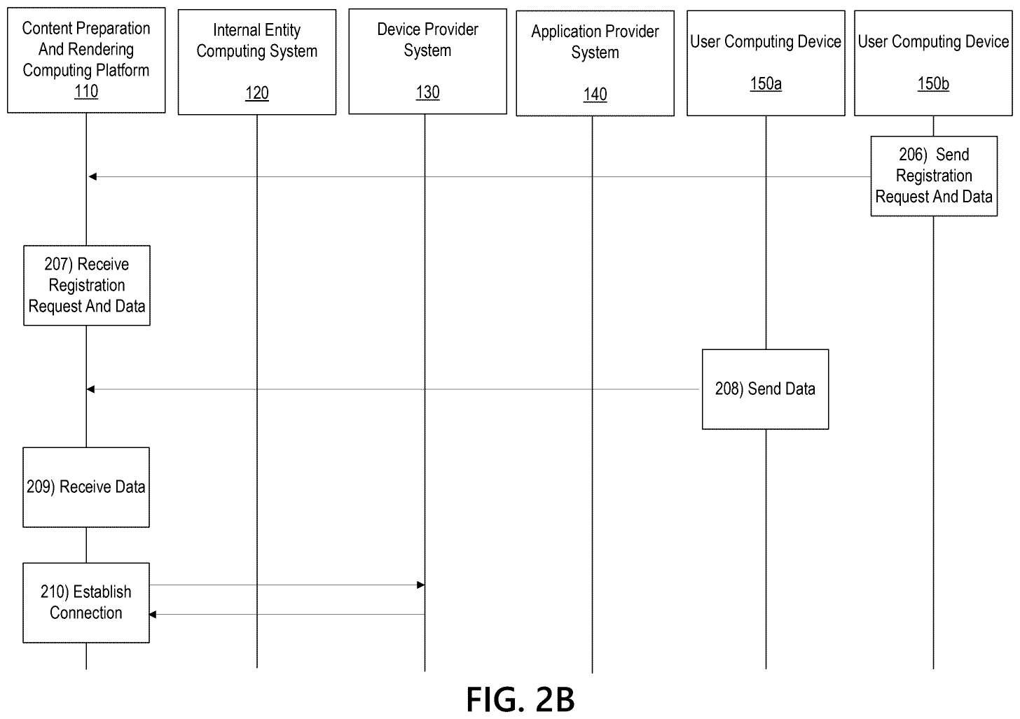

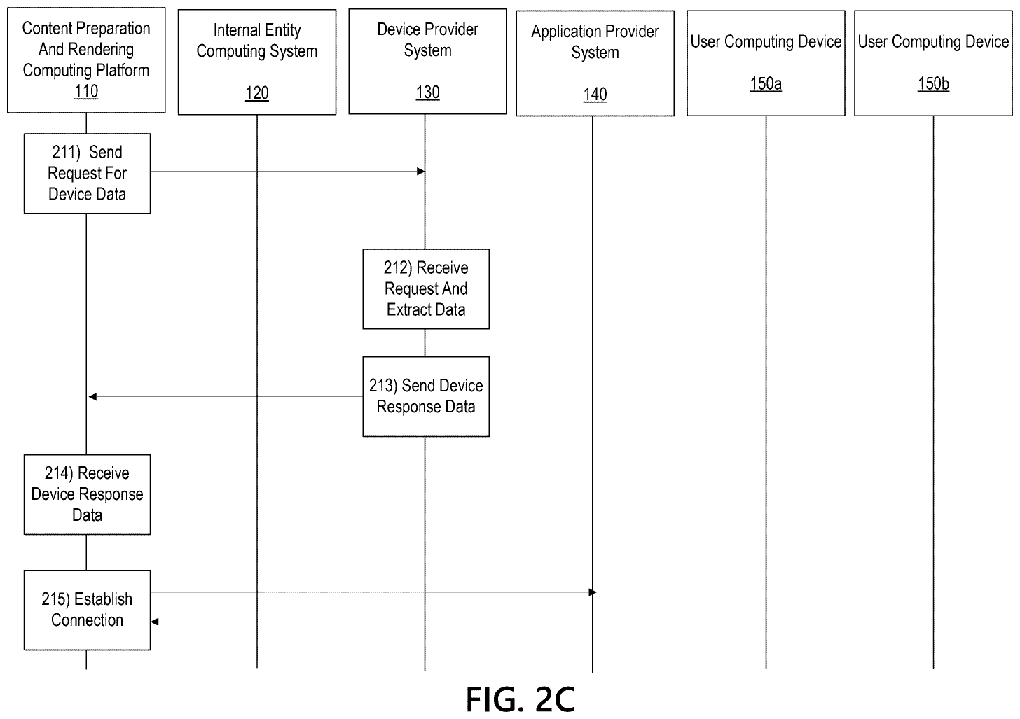

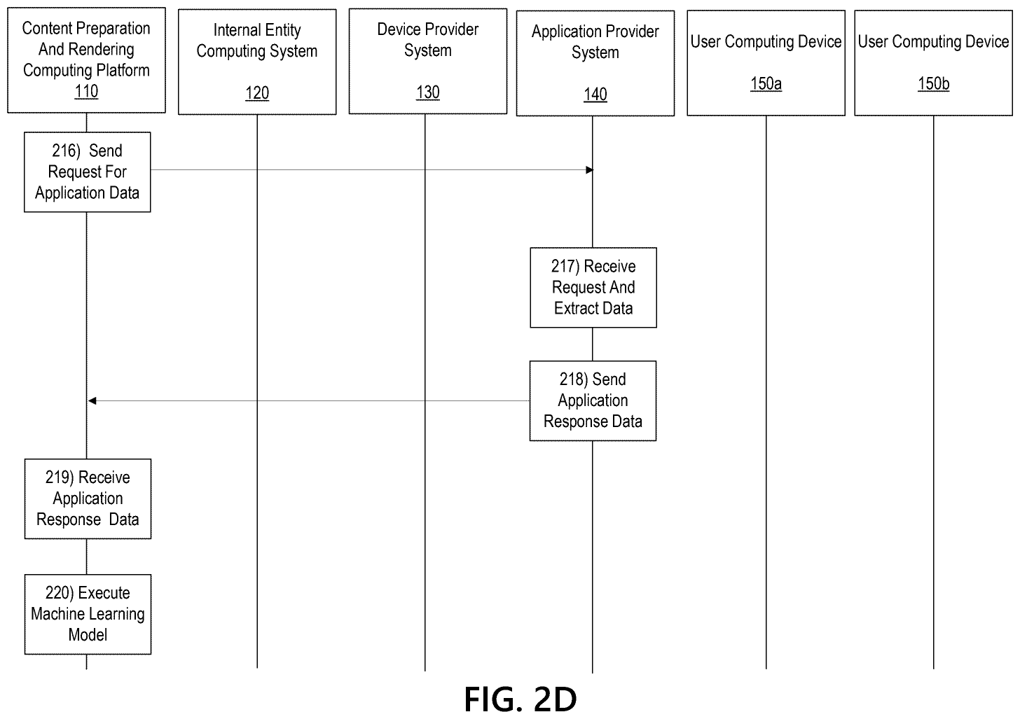

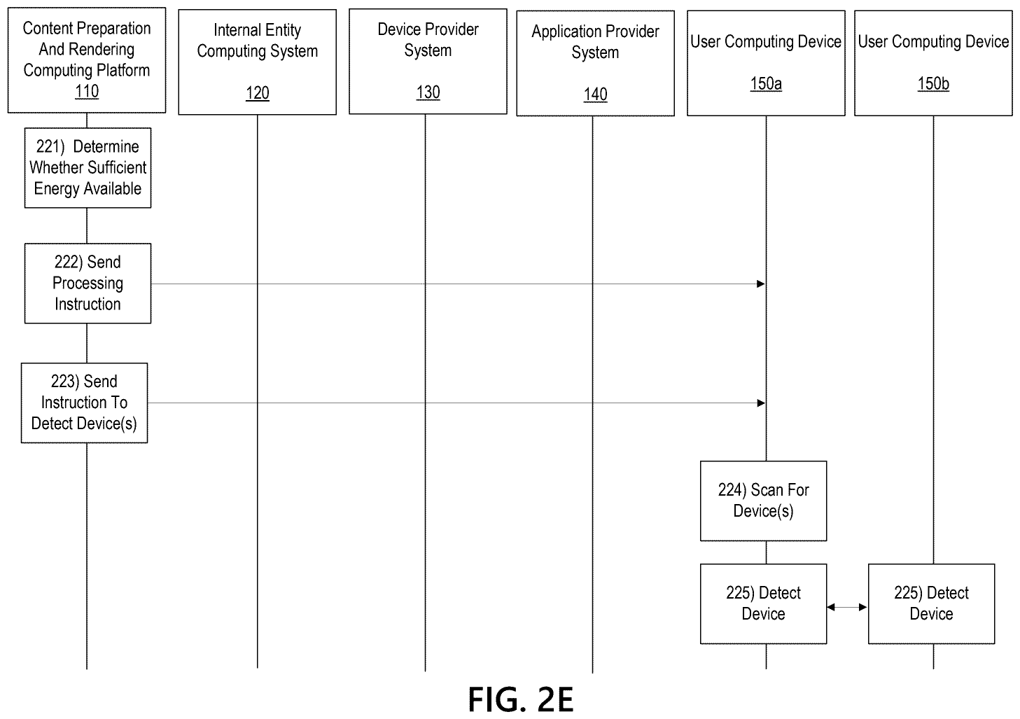

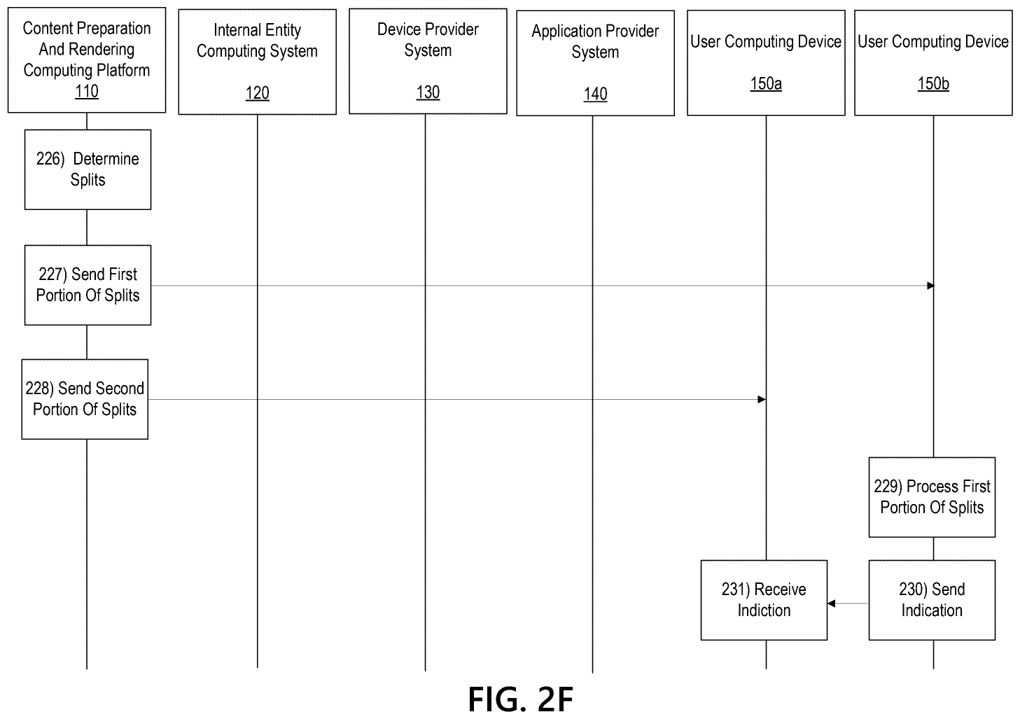

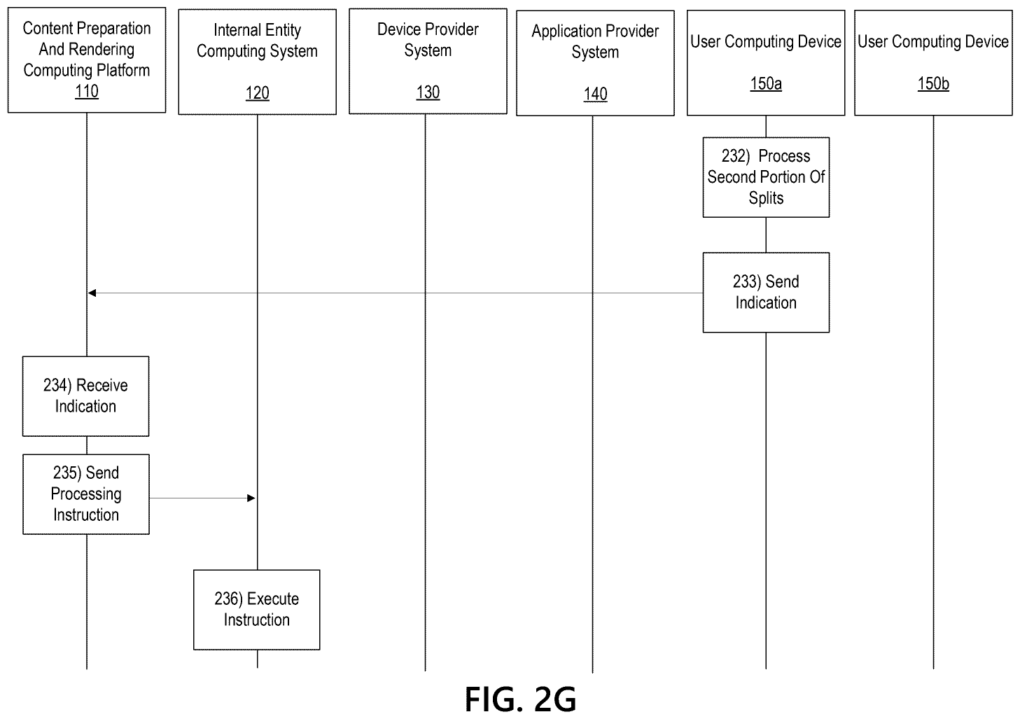

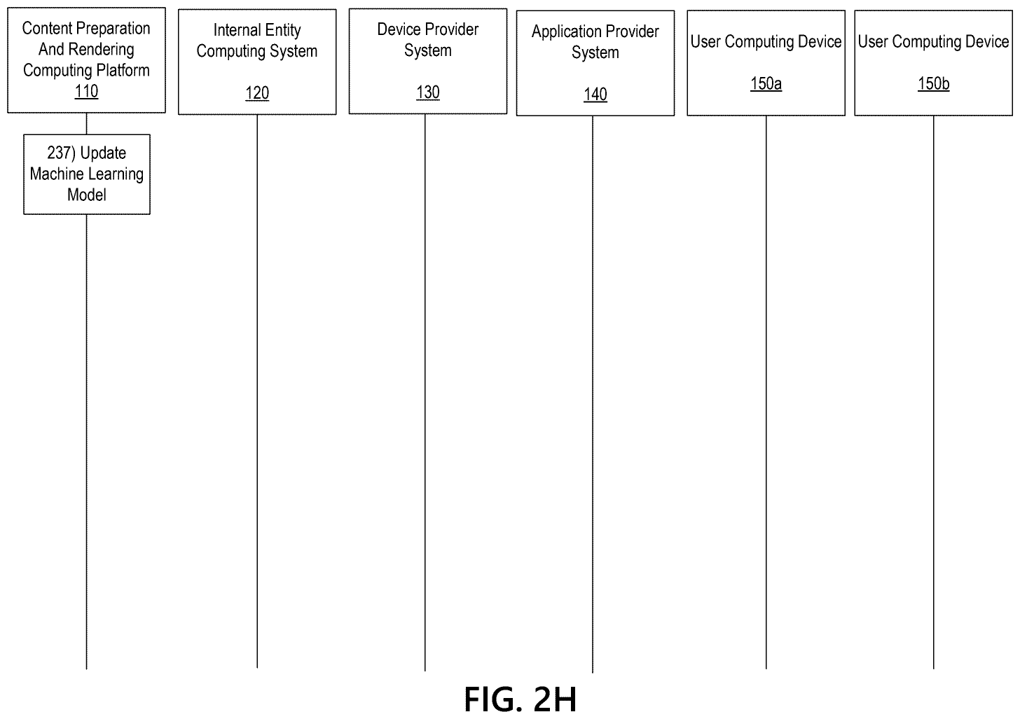

FIGS. 2A-2H depict one example illustrative event sequence for content preparation and rendering based on device energy level in accordance with one or more aspects described herein. The events shown in the illustrative event sequence are merely one example sequence and additional events may be added, or events may be omitted, without departing from the invention. Further, one or more processes discussed with respect to FIGS. 2A-2H may be performed in real-time or near real-time.

With reference to FIG. 2A, at step 201, content preparation and rendering computing platform 110 may receive data. For instance, content preparation and rendering computing platform 110 may receive historical data associated with energy levels and device processing needs, application usage and associated energy consumption, transaction and associated API calls and/or energy consumption, battery capacity, and the like.

At step 202, content preparation and rendering computing platform 110 may train a machine learning model. For instance, content preparation and rendering computing platform 110 may train a machine learning model based on, for instance, the data received at step 201, to identify patterns or correlations in subsequent data. For instance, content preparation and rendering computing platform 110 may train the machine learning model to receive, as inputs, current energy level of a device, current application usage, expected or scheduled transaction data, and the like, and may output an expected consumption rate of energy for the device and a determination of whether sufficient energy will be available to process a scheduled or expected transaction.

Content preparation and rendering computing platform 110 may establish connections with one or more devices to obtain registration data. Although in FIG. 2A connection are established to two devices, in some examples, a connection to a single device may be used to receive registration data for all desired devices, or connections to more than two devices may be established to obtain the desired registration data.

At step 203, content preparation and rendering computing platform 110 may establish a connection with user computing device 150a. For instance, content preparation and rendering computing platform 110 may establish a first wireless connection with user computing device 150a. Upon establishing the first wireless connection, a communication session may be initiated between content preparation and rendering computing platform 110 and user computing device 150a.

At step 204, content preparation and rendering computing platform 110 may establish a connection with user computing device 150b. For instance, content preparation and rendering computing platform 110 may establish a second wireless connection with a second device, such as user computing device 150b. Upon establishing the second wireless connection, a communication session may be initiated between content preparation and rendering computing platform 110 and user computing device 150b.

At step 205, user computing device 150a may transmit or send a request for registration and registration data to the content preparation and rendering computing platform 110. For instance, user computing device 150a may transmit or send a request to register with content preparation and rendering computing platform 110 (e.g., including permissions for monitoring energy consumption, and the like) and data associated with a type of device, a manufacturer and model of the device 150a, a unique identifier associated with user computing device 150a, user identifying data associated with a user of user computing device 150a, and the like.

With reference to FIG. 2B, at step 206, user computing device 150b may transmit or send a request for registration and registration data to the content preparation and rendering computing platform 110. For instance, user computing device 150b may transmit or send a request to register with content preparation and rendering computing platform 110 (e.g., including permissions for monitoring energy consumption, and the like) and data associated with a type of device, a manufacturer and model of the device 150b, a unique identifier associated with user computing device 150b, user identifying data associated with a user of user computing device 150b, and the like.

At step 207, content preparation and rendering computing platform 110 may receive the registration request and data from user computing device 150a and user computing device 150b and may store the data. For instance, the data may be stored in database 112h.

At step 208, user computing device 150a may transmit or send current device data. For instance, user computing device 150a may transmit or send a current energy level or capacity, current application usage data (e.g., applications executing in the background and foreground), scheduled or expected transaction data (e.g., based on one or more calendar applications), and the like, to the content preparation and rendering computing platform 110.

At step 209, content preparation and rendering computing platform 110 may receive the current device data received from user computing device 150a.

At step 210, content preparation and rendering computing platform 110 may establish a connection with device provider system 130. For instance, content preparation and rendering computing platform 110 may establish a third wireless connection with device provider system 130. Upon establishing the third wireless connection, a communication session may be initiated between content preparation and rendering computing platform 110 and device provider system 130.

With reference to FIG. 2C, at step 211, content preparation and rendering computing platform 110 may transmit or send a request for device benchmark data to the device provider system 130. For instance, content preparation and rendering computing platform 110 may transmit or send a type of device associated with user computing device 150a and may request, from device provider system 130, data associated with energy capacity and/or energy consumption, as determined by the manufacturer.

At step 212, device provider system 130 may receive and process the request and may extract the requested data.

At step 213, device provider system 130 may transmit or send device response data to the content preparation and rendering computing platform 110.

At step 214, content preparation and rendering computing platform 110 may receive the device response data.

At step 215, content preparation and rendering computing platform 110 may establish a connection with application provider system 140. For instance, content preparation and rendering computing platform 110 may establish a fourth wireless connection with application provider system 140. Upon establishing the fourth wireless connection, a communication session may be initiated between content preparation and rendering computing platform 110 and application provider system 140.

With reference to FIG. 2D, at step 216, content preparation and rendering computing platform 110 may transmit or send a request for application benchmark data to application provider system 140. Although one application provider system 140 is shown, in some examples, content preparation and rendering computing platform 110 may connect to multiple application provider systems to obtain data associated with one or more applications executing on user computing device 150a.

For instance, content preparation and rendering computing platform 110 may transmit or send identification of one or more applications executing on user computing device 150a (e.g., based on the current device data) and may request, from application provider system 140, data associated with energy consumption for that application, as determined by the developer or application provider of the application.

At step 217, application provider system 140 may receive and process the request for data and may extract the requested data.

At step 218, application provider system 140 may transmit or send the application response data to the content preparation and rendering computing platform 110.

At step 219, content preparation and rendering computing platform 110 may receive the application response data from the application provider system 140.

At step 220, content preparation and rendering computing platform 110 may execute a machine learning model. For instance, content preparation and rendering computing platform 110 may input, to the machine learning model, the current device data associated with user computing device 150a (e.g., current energy level, application usage data, scheduled transaction data, and the like), as well as the device and application data received. Upon execution of the machine learning model, the machine learning model may output an expected or predicted rate of consumption for the user computing device 150a. In some examples, the predicted rate of consumption may be for a period of time (e.g., 24 hours, a remaining time in a calendar day, 12 hours, or the like).

With reference to FIG. 2E, at step 221, the machine learning model may also output a determination of whether sufficient energy is expected to be available at user computing device 150a at a time of a scheduled transaction to process the transaction. In some examples, the determination of whether sufficient energy will be available may be based on the predicted consumption rate and a threshold amount of energy remaining before alternate processing is initiated. For instance, if the determined consumption rate indicates that, at the time of the scheduled transactions, the remaining battery will be a percentage below a predetermined threshold percentage, alternative processing may be initiated. If the amount is at or above the threshold (e.g., sufficient energy is expected to be available), the process may proceed to step 222.

At step 222, content preparation and rendering computing platform 110 may send a processing instruction to user computing device 150a. For instance, content preparation and rendering computing platform 110 may transmit or send a processing instruction to user computing device 150a indicating that the transaction processing should proceed as scheduled. The process may then proceed to step 234 at FIG. 2G.

If, at step 221, the machine learning model outputs an indication that sufficient energy is not expected to be available to process the transaction at user computing device 150a (e.g., the consumption rate indicates the remaining battery will be below the threshold at a predetermined time), at step 223, content preparation and rendering computing platform 110 may transmit or send an instruction to user computing device 150a to detect one or more nearby registered devices to aid or share in processing the transaction to reduce the power consumption needed by user computing device 150a to process the transaction.

At step 224, user computing device 150a may receive and execute the instruction and may scan for nearby devices. In some examples, the instruction may include a time of execution. For instance, the instruction may include an instruction to scan for nearby devices at a time near to the time of the scheduled transaction (e.g., within 1 hour, 30 minutes, 5 minutes, or the like).

At step 225, user computing device 150a may detect nearby registered user computing device 150b. For instance, user computing device 150a may detect user computing device 150b based on near-field communication or other short-range communication protocol.

With reference to FIG. 2F, at step 226, content preparation and rendering computing platform 110 may divide the scheduled transaction into a plurality of split transactions (e.g., “splits”) that may enable size-limited (e.g., “light”) processing of the transaction or otherwise reduce the energy load needed by one device to process the transaction. In some examples, the plurality of splits, as well as an order in which the splits will be processed, may be identified or determined by the machine learning model. For instance, a type or category of transaction associated with the scheduled transaction may be input to the machine learning model and the machine learning model may output a plurality of splits associated with processing the transaction and an order in which the splits will be performed to process the transaction.

At step 227, content preparation and rendering computing platform 110 may transmit or send a first portion of the plurality of splits to user computing device 150b for execution. At step 228, content preparation and rendering computing platform 110 may transmit or send a second portion of the splits to user computing device 150a for execution. In some examples, each split may be transmitted or sent one at a time to ensure processing in the correct order. Additionally or alternatively, a batch of splits forming the first portion or second portion may be sent together and executed in a designated order.

At step 229, user computing device 150b may process the first portion of the plurality of splits. Upon completion of the processing of the first plurality of splits, user computing device 150b may transmit or send an indication that the first plurality of splits was processed to the user computing device 150a at step 230. At step 231, user computing device 150a may receive the indication that the first plurality of splits was processed.

With reference to FIG. 2G, at step 232, in response to receiving the indication that the first plurality of splits was processed, user computing device 150a may process the second portion of the plurality of splits. For instance, receiving the indication of completion of processing of the first portion of the plurality of splits may cause the user computing device 150a to process the second portion of the plurality of splits.

At step 233, user computing device 150a may transmit or send an indication of processing to the content preparation and rendering computing platform 110. At step 234, content preparation and rendering computing platform 110 may receive the indication of processing from the user computing device 150a.

At step 235, in some examples, content preparation and rendering computing platform 110 may send a processing instruction to internal entity computing system 120. For instance, content preparation and rendering computing platform 110 may send an instruction to update one or more account ledgers, transfer funds, or the like, based on the indication of processing received from user computing device 150a.

At step 236, internal entity computing system 120 may receive and execute the instruction. While the figures show the processing instruction being transmitted by the content preparation and rendering computing platform 110, in some examples, user computing device 150a may communicate directly with internal entity computing system 120 to process the transaction and/or finalize processing of the transaction.

With reference to FIG. 2H, at step 237, content preparation and rendering computing platform 110 may update and/or validate the machine learning model. For instance, based on the availability of energy at the time of the scheduled transaction, number of splits, processing of splits, and the like, the machine learning model may be updated and/or validated to continuously improve accuracy of predicted energy consumption and availability of sufficient energy to process transactions.

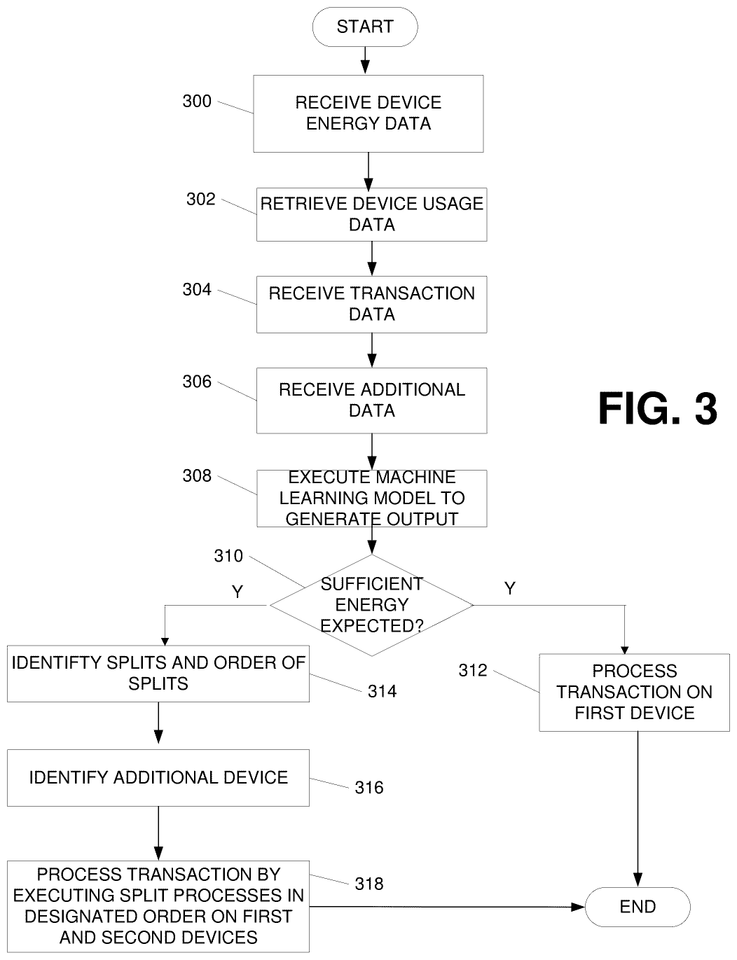

FIG. 3 is a flow chart illustrating one example method content preparation and rendering based on device energy levels in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, content preparation and rendering computing platform 110 may receive current device energy data for a first registered device. For instance, for a particular user computing device, such as user computing device 150a, a current energy level (e.g., battery life, battery consumed, or the like) may be received from the user computing device 150a. In some arrangements, the first registered device, user computing device 150a, may be a wearable device with limited battery capacity. In some examples, the data may be received from user computing device 150a at a predetermined time of day, based on a predetermined schedule (e.g., every 24 hours), or the like. In some examples, the process described may be performed each day of the week, each business day, or the like, to evaluate energy levels and consumption, determine whether sufficient energy will be available to process transactions, and the like. Accordingly, predictions may be made for a period of time and then, upon a next receipt of device data, a new projection or prediction may be generated based on current data at that time.

At step 302, content preparation and rendering computing platform 110 may receive current device usage data for the first registered device (e.g., user computing device 150a). For instance, current usage data associated with one or more applications executing on the user computing device 150a may be received. The one or more applications may be active on user computing device 150a, may be operating or executing in the background, or the like.

At step 304, content preparation and rendering computing platform 110 may receive transaction data. For instance, data associated with one or more transactions scheduled to be executed by the user computing device 150a on a current day may be received. In some examples, the scheduled transaction data may include a category of a scheduled transaction, as well as a number of API calls associated with processing transactions of that category.

In some examples, content preparation and rendering computing platform 110 may receive additional data from one or more devices or systems. For instance, content preparation and rendering computing platform 110 may receive device energy data, application energy consumption data, and the like, from one or more publicly available sources, such as device provider system 130, application provider system 140, and the like.

At step 308, content preparation and rendering computing platform 110 may execute a machine learning model. For instance, content preparation and rendering computing platform 110 may input, to the machine learning model, the current device energy level, current device usage data for user computing device 150a, and transaction data and may output a projected consumption rate of energy for the first registered device (user computing device 150a) and a determination of whether sufficient energy is expected to be available to process a scheduled transaction. determined from the transaction data, at the schedule time. In some examples, the additional data related to the device and/or the applications may also be input to the machine learning model to generate the outputs described.

At step 310, the content preparation and rendering computing platform 110 may determine whether sufficient energy is expected to be available based on the output generated by the machine learning model. If so, the transaction may be processed by user computing device 150a at the scheduled time at step 312 and the process may end.

If sufficient energy is not expected to be available, at step 314, the machine learning model may identify a plurality of transaction splits associated with the transaction (e.g., the model may divide the scheduled transaction into a plurality of splits to enable processing via reduced computing load). The machine learning model may also identify an order or sequence in which the plurality of splits will be executed to process the transaction.

At step 316, one or more additional devices may be identified to process a portion of the plurality of splits. For instance, one or more additional computing devices, such as second user computing device 150b may be detected via a near-field communication, Bluetooth, or other short-range communication protocol based on a proximity to user computing device 150a.

At step 318, a first portion of the plurality of splits may be transmitted to the second computing device 150b for execution and a second portion of the plurality of splits may be transmitted to the first registered device (e.g., user computing device 150a) for execution. Each device may process the splits received in the order or sequence identified in order to process the scheduled transaction.

Accordingly, aspects described herein provide for evaluation of device energy levels prior to processing transactions to ensure sufficient energy will be available to process transactions. As discussed herein, devices such as wearable devices, often have limited battery capacity. That capacity can be quickly depleted if applications such as GPS, navigation, gaming, and the like, are being used on the device, and may deplete the battery to a point where scheduled transactions might not be completed due to insufficient energy resources.

Accordingly, as discussed, machine learning can be used to evaluate current conditions at a device to determine whether sufficient energy will be available to process scheduled transactions and, if not, distribute transaction processing across multiple devices.

In some examples, the devices used to process the transactions may be all associated with a same network or may be associated with different networks. Further, to ensure availability, the machine learning model may be a cloud-based model to monitor devices, usage, predict energy consumption, and the like.

As discussed herein, in some examples, the machine learning model may determine an amount of time needed to process a transaction. For instance, based on a number of functions and associated API calls associated with various categories of transactions, the model may predict a consumption rate. Further, the model may, in some examples, account for manufacturer or application developer benchmark data (e.g., expected battery life, consumption rates, and the like).

Further, while aspects described herein are directed to a machine learning model identifying a plurality of splits and an order or sequence in which the splits will be executed, in some examples, the splits may be identified by a transaction provider and sent to the devices for processing in the designated order. For splits of the transaction that require user input, a trigger or notification may be provided to the user requesting the user input (e.g., provide authentication data, confirm amount for transfer, or the like).

While various aspects described herein are directed to using another user device (e.g., another registered user device) to perform a portion of the transaction by execution a portion of the transaction splits, in some examples, other devices may be used. For instance, an automated teller machine (ATM) (e.g., associated with the enterprise organization associated with the content preparation and rendering computing device 110) may be nearby and available to connect to the user device via near-field communication, Bluetooth, or other short-range communication protocol. Accordingly, in some examples, a portion of the plurality of splits may be transmitted to the ATM for execution. For instance, a user may authenticate to the ATM and, in response, a portion of the splits may be transmitted to the ATM for execution.

Further, in some examples, functionality of the device itself (e.g., user computing device 150a) may be limited based on the device energy level being below a threshold or expected to be below a threshold. For instance, a faraday strip may be used to prevent transmission of data while maintaining the ability of the device to be used for phone calls or other emergency situations.

In some arrangements, the content preparation and rendering computing platform 110 may further determine whether updates are expected for the user computing device 150a. If so, the computing platform 110 may determine whether the updates are technical in nature and, if not, may hold the update until the device 150a is charging or connected to a power source, or the like.

As discussed herein, the machine learning model may be trained using data associated with a plurality of users to enable improved accuracy in predictions. As discussed, training data related to interactions with devices of a particular type, types of applications being used, transactions being performed, and the like, can be used to train the model.

In some examples, if low energy is detected, some notifications may be held or converted to lower energy notifications (e.g., PDF, or the like). In some arrangements, notifications may be transmitted to an alternate user device when low energy is detected at user computing device 150a.

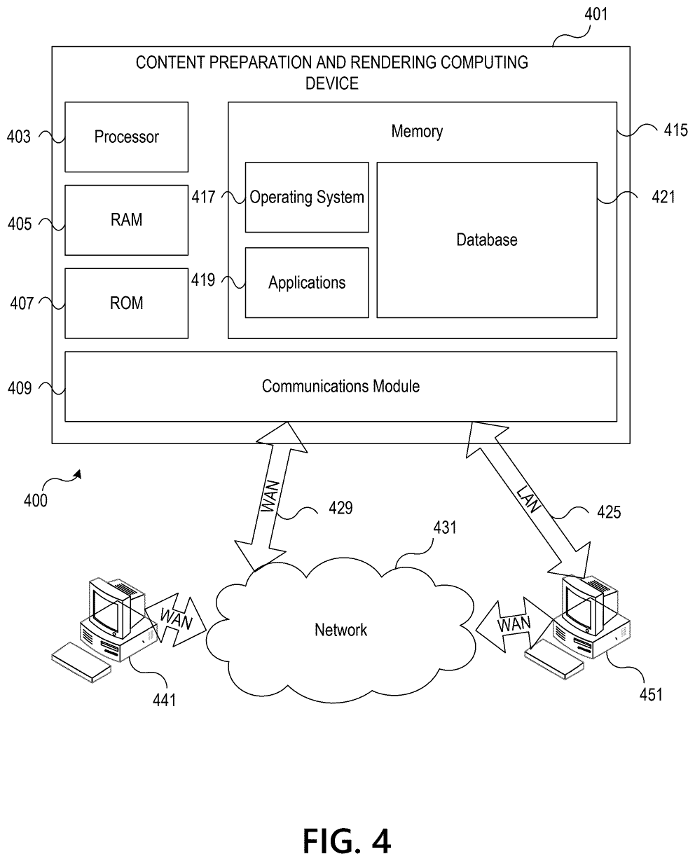

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include content preparation and rendering computing device 401 having processor 403 for controlling overall operation of content preparation and rendering computing device 401 and its associated components, including Random Access Memory (RAM) 405, Read-Only Memory (ROM) 407, communications module 409, and memory 415. Content preparation and rendering computing device 401 may include a variety of computer readable media. Computer readable media may be any available media that may be accessed by content preparation and rendering computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by content preparation and rendering computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on content preparation and rendering computing device 401. Such a processor may execute computer-executable instructions stored on a computer-readable medium.

Software may be stored within memory 415 and/or storage to provide instructions to processor 403 for enabling content preparation and rendering computing device 401 to perform various functions as discussed herein. For example, memory 415 may store software used by content preparation and rendering computing device 401, such as operating system 417, application programs 419, and associated database 421. Also, some or all of the computer executable instructions for content preparation and rendering computing device 401 may be embodied in hardware or firmware. Although not shown, RAM 405 may include one or more applications representing the application data stored in RAM 405 while content preparation and rendering computing device 401 is on and corresponding software applications (e.g., software tasks) are running on content preparation and rendering computing device 401.

Communications module 409 may include a microphone, keypad, touch screen, and/or stylus through which a user of content preparation and rendering computing device 401 may provide input, and may also include one or more of a speaker for providing audio output and a video display device for providing textual, audiovisual and/or graphical output. Computing system environment 400 may also include optical scanners (not shown).

Content preparation and rendering computing device 401 may operate in a networked environment supporting connections to one or more remote computing devices, such as computing devices 441 and 451. Computing devices 441 and 451 may be personal computing devices or servers that include any or all of the elements described above relative to content preparation and rendering computing device 401.

The network connections depicted in FIG. 4 may include Local Area Network (LAN) 425 and Wide Area Network (WAN) 429, as well as other networks. When used in a LAN networking environment, content preparation and rendering computing device 401 may be connected to LAN 425 through a network interface or adapter in communications module 409. When used in a WAN networking environment, content preparation and rendering computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive current device energy level data from a first registered device associated with a user;
receive current device usage data for the first registered device associated with the user;
receive scheduled transaction data for the first registered device associated with the user;
execute a machine learning model, wherein executing the machine learning model includes providing, as inputs to the machine learning model, the current device energy level data, current device usage data and scheduled transaction data for the first registered device to output a predicted consumption rate of energy of the first registered device associated with the user and a projection of whether the first registered device associated with the user will have sufficient energy to complete a scheduled transaction identified from the scheduled transaction data;
responsive to the projection of whether the first registered device will have sufficient energy to complete the scheduled transaction including a projection that the first registered device will have sufficient energy, cause processing of the scheduled transaction at the first registered device at a scheduled time;
responsive to the projection of whether the first registered device will have sufficient energy to complete the scheduled transaction including a projection that the first registered device will not have sufficient energy:
divide the scheduled transaction into a plurality of splits;
identify an order of execution of the plurality of splits;
identify a second registered device associated with the user;
send a first portion of the plurality of splits to the second registered device;
send a second portion of the plurality of splits to the first registered device; and
cause execution of the first portion of the plurality of splits on the second registered device associated with the user and the second portion of the plurality of splits on the first registered device associated with the user in the identified order of execution, wherein executing the first portion of the plurality of splits and the second portion of the plurality of splits processes the scheduled transaction.

2. The computing platform of claim 1, wherein the first registered device is a wearable device.

3. The computing platform of claim 1, wherein executing the machine learning model further includes:
retrieving, based on a type of the first registered device, manufacturer data associated with energy usage of the type of the first registered device; and
inputting the manufacturer data into the machine learning model as an additional input to output the predicted consumption rate of energy of the first registered device associated with the user and the projection of whether the first registered device associated with the user will have sufficient energy to complete the scheduled transaction identified from the scheduled transaction data.

4. The computing platform of claim 1, wherein the current device usage data includes identification of one or more applications executing on the first registered device.

5. The computing platform of claim 4, wherein executing the machine learning model further includes:
retrieving, based on the one or more applications executing on the first registered device, application provider data associated with energy usage for each application of the one or more applications; and
inputting the application provider data into the machine learning model as an additional input to output the predicted consumption rate of energy of the first registered device associated with the user and the projection of whether the first registered device associated with the user will have sufficient energy to complete the scheduled transaction identified from the scheduled transaction data.

6. The computing platform of claim 1, wherein the scheduled transaction data includes a category of transaction of the scheduled transaction and a number of API calls associated with the category of transaction.

7. The computing platform of claim 1, wherein dividing the scheduled transaction into the plurality of splits is performed by the machine learning model.

8. The computing platform of claim 1, wherein identifying the order of execution of the plurality of splits is performed by the machine leaning model.

9. The computing platform of claim 1, wherein identifying the second registered device is based on the second registered device being detected by the first registered device via a short-range communication protocol.

10. A method, comprising:
receiving, by a computing platform, the computing platform having at least one processor, and memory, current device energy level data from a first registered device associated with a user;
receiving, by the at least one processor, current device usage data for the first registered device associated with the user;
receiving, by the at least one processor, scheduled transaction data for the first registered device associated with the user;
executing, by the at least one processor, a machine learning model, wherein executing the machine learning model includes providing, as inputs to the machine learning model, the current device energy level data, current device usage data and scheduled transaction data for the first registered device to output a predicted consumption rate of energy of the first registered device associated with the user and a projection of whether the first registered device associated with the user will have sufficient energy to complete a scheduled transaction identified from the scheduled transaction data;
responsive to the projection of whether the first registered device will have sufficient energy to complete the scheduled transaction including a projection that the first registered device will have sufficient energy, causing, by the at least one processor, processing of the scheduled transaction at the first registered device at a scheduled time;
responsive to the projection of whether the first registered device will have sufficient energy to complete the scheduled transaction including a projection that the first registered device will not have sufficient energy:
dividing, by the at least one processor, the scheduled transaction into a plurality of splits;
identifying, by the at least one processor, an order of execution of the plurality of splits;
identifying, by the at least one processor, a second registered device associated with the user;
sending, by the at least one processor, a first portion of the plurality of splits to the second registered device;
sending, by the at least one processor, a second portion of the plurality of splits to the first registered device; and
causing, by the at least one processor, execution of the first portion of the plurality of splits on the second registered device associated with the user and the second portion of the plurality of splits on the first registered device associated with the user in the identified order of execution, wherein executing the first portion of the plurality of splits and the second portion of the plurality of splits processes the scheduled transaction.

11. The method of claim 10, wherein the first registered device is a wearable device.

12. The method of claim 10, wherein executing the machine learning model further includes:
retrieving, by the at least one processor and based on a type of the first registered device, manufacturer data associated with energy usage of the type of the first registered device; and
inputting, by the at least one processor, the manufacturer data into the machine learning model as an additional input to output the predicted consumption rate of energy of the first registered device associated with the user and the projection of whether the first registered device associated with the user will have sufficient energy to complete the scheduled transaction identified from the scheduled transaction data.

13. The method of claim 10, wherein the current device usage data includes identification of one or more applications executing on the first registered device.

14. The method of claim 13, wherein executing the machine learning model further includes:
retrieving, by the at least one processor and based on the one or more applications executing on the first registered device, application provider data associated with energy usage for each application of the one or more applications; and
inputting, by the at least one processor, the application provider data into the machine learning model as an additional input to output the predicted consumption rate of energy of the first registered device associated with the user and the projection of whether the first registered device associated with the user will have sufficient energy to complete the scheduled transaction identified from the scheduled transaction data.

15. The method of claim 10, wherein the scheduled transaction data includes a category of transaction of the scheduled transaction and a number of API calls associated with the category of transaction.

16. The method of claim 10, wherein dividing the scheduled transaction into the plurality of splits is performed by the machine learning model.

17. The method of claim 10, wherein identifying the order of execution of the plurality of splits is performed by the machine leaning model.

18. The method of claim 10, wherein identifying the second registered device is based on the second registered device being detected by the first registered device via a short-range communication protocol.

19. One or more non-transitory computer-readable media storing instructions that, when executed by a computing platform comprising at least one processor, memory, and a communication interface, cause the computing platform to:
receive current device energy level data from a first registered device associated with a user;
receive current device usage data for the first registered device associated with the user;
receive scheduled transaction data for the first registered device associated with the user;
execute a machine learning model, wherein executing the machine learning model includes providing, as inputs to the machine learning model, the current device energy level data, current device usage data and scheduled transaction data for the first registered device to output a predicted consumption rate of energy of the first registered device associated with the user and a projection of whether the first registered device associated with the user will have sufficient energy to complete a scheduled transaction identified from the scheduled transaction data;
responsive to the projection of whether the first registered device will have sufficient energy to complete the scheduled transaction including a projection that the first registered device will have sufficient energy, cause processing of the scheduled transaction at the first registered device at a scheduled time;
responsive to the projection of whether the first registered device will have sufficient energy to complete the scheduled transaction including a projection that the first registered device will not have sufficient energy:
divide the scheduled transaction into a plurality of splits;
identify an order of execution of the plurality of splits;
identify a second registered device associated with the user;
send a first portion of the plurality of splits to the second registered device;
send a second portion of the plurality of splits to the first registered device; and
cause execution of the first portion of the plurality of splits on the second registered device associated with the user and the second portion of the plurality of splits on the first registered device associated with the user in the identified order of execution, wherein executing the first portion of the plurality of splits and the second portion of the plurality of splits processes the scheduled transaction.

20. The one or more non-transitory computer-readable media of claim 19, wherein the first registered device is a wearable device.
